(19) United States
(12) Patent Application Publication
(10) Pub. No.: US 2025/0078009 A1
(43) Pub. Date: Mar. 6, 2025

(54) SYSTEM AND METHOD OF CALCULATING SUPERVISOR IMPACT SCORE

(71) Applicant: NICE LTD., Ra'anana (IL)

(72) Inventors: Swapnil THAKARE, Pune (IN); Gennadi LEMBERSKY, Haifa (IL); Brijesh UPADHYAY, Pune (IN); Abhijit MOKASHI, Pune (IN)

(21) Appl. No.: 18/458,553

(22) Filed: Aug. 30, 2023

(51) Int. Cl. G06Q 10/0639; H04M 3/51

(52) U.S. Cl. CPC G06Q 10/06398; H04M 3/5175; H04M 2203/401; H04M 2203/403

(57) ABSTRACT

Systems adapted to measure impact of supervisor actions and methods, and non-transitory computer readable media, include identifying an interaction where a contact center supervisor performed a supervisor action, where the supervisor supervised a contact center agent; identifying a supervisor intervention point in the interaction; determining an impact score for each of a plurality of behavioral factors; aggregating the impact scores for the plurality of behavioral factors and determining an average of the impact scores to provide an overall impact score for the supervisor action; and performing an action automatically based on the overall impact score to improve contact center performance.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The present disclosure relates generally to methods and systems of calculating a supervisor impact score, and more specifically relates to methods and systems of utilizing supervisor impact scores to implement automated actions to improve contact center performance, such as targeted employee training, improved employee feedback, improved employee training, improved employee hours scheduling, and enhanced employee motivation efforts.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized (or be conventional or well-known) in the prior art. The subject matter in the background section merely represents different approaches, which in and of themselves may also be inventions.

Understanding how supervisor actions help agents and impact customer experience is critical for any contact center organization. Supervisor actions primarily include monitoring and coaching the agent, and joining or taking over customer interactions, as necessary. Measuring the impact of supervisor actions is important to help improve supervisor skills, manage supervisor staffing and scheduling, and compare and incentivize supervisors. Further, supervisor impact scores may indicate coaching/staffing needs of the contact center in terms of both agents and supervisors. Currently, a supervisor is allowed to monitor, join, or coach an agent during a live interaction, but there is no way to measure and track supervisor impact.

Accordingly, there is a need to better determine the impact a supervisor has on a customer experience to improve customer experience.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designations have the same or similar functions.

FIG. 1 is a simplified block diagram of a system according to various aspects of the present disclosure.

FIG. 2 is a flowchart of a method of measuring impact of supervisor actions according to embodiments of the present disclosure.

FIG. 3 is a flowchart of a method of identifying interactions that should be sampled for an impact score according to embodiments of the present disclosure.

FIG. 4 illustrates an automatic coaching distributor module according to embodiments of the present disclosure.

FIG. 5 illustrates an exemplary user interface that allows a user to view impact scores of supervisors over a selected date range according to embodiments of the present disclosure.

FIG. 6 illustrates an exemplary user interface that helps a user to understand how a supervisor impacted an individual interaction along with other information regarding the interaction according to embodiment of the present disclosure.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The systems and methods described herein calculate a supervisor impact score, also referred to herein as an impact score. In various embodiments, the impact score is calculated by first sampling the customer interactions where a supervisor intervened, and then calculating the impact score of the supervisor. In one or more embodiments, an interaction to be considered in the impact score calculation is sampled based on inputs provided during the time when a supervisor is taking actions. This can be measured as the duration of talk time for a voice interaction or the number of messages for digital interactions. Interaction sampling identifies the “good” interactions where the supervisor provided a considerable contribution.

In several embodiments, once the appropriate interactions are determined, the impact score is calculated by identifying the supervisor intervention point, running one or more models on the part of the interaction before the supervisor intervention point, running the one or more models on the entire interaction, calculating the impact score for each model by comparing the state of the customer experience before and after a supervisor's action, and calculating an overall impact score by aggregating all the individual impact scores for each model. The calculated difference between the individual impact scores before and after a supervisor's action informs whether the supervisor's action had a positive or negative impact. The impact score can be calculated for multiple intervention points, such as coaching, joining the interaction, or taking over an interaction.

In certain embodiments, the one or more models used in the impact score calculation are different sentiment models that reflect agent behavior in the interaction. The state of these models or behavioral factors needs to be collected before supervisor intervention and at the end of the interaction. This can help in the calculation of how the supervisor's intervention impacted agent behavior and affected a customer's experience. In an exemplary embodiment, the one or more models or behavioral factors used to calculate the impact score includes one or more of “demonstrate ownership,” “active listening,” “be empathetic,” “build rapport,” “set expectations,” “effective questioning,” “promote self-service,” “inappropriate action,” “acknowledge loyalty,” “speech velocity,” and “interruption.” An explanation of each model or behavioral factor is provided below in Table 1.

TABLE 1
EXPLANATION OF MODELS/BEHAVIORAL FACTORS

| MODEL/ | |
|---|---|
| BEHAVIORAL | |
| FACTOR | EXPLANATION |
| Demonstrate Ownership | Reassuring the customer that the |
| | representative understands the issue and is |
| | ready and able to help. |
| Active Listening | Actively responding in the conversation, and |
| | not asking customer to repeat themselves. |
| Be Empathetic | Acknowledging stated issues, and their |
| | related impacts/hardships to the customer. |
| Build Rapport | Engaging the customer in general dialog not |
| | specific to the reason for contacting to build a |
| | personal connection. |
| Set Expectations | Summarizing actions and next steps, |
| | informing the customer of what to expect |
| | and/or required actions. |
| Effective Questioning | Asking meaningful questions to explore the |
| | customer's experience, issues, and/or |
| | opportunities. |
| Promote Self-Service | Promoting the availability of self-service |
| | options (IVR, website, application) where |
| | appropriate during an interaction |
| Inappropriate Action | Denying the customer's request to transfer the |
| | contact, use of inappropriate language, and |
| | other offensive acts. |
| Acknowledge Loyalty | Taking a moment to acknowledge the |
| | customer's tenure with the organization and |
| | showing appreciation for their loyalty. |
| Speech Velocity | Higher values indicate a faster rate of speech. |
| Interruption | A detector of speaking over the customer or |
| | not letting the customer finish their sentence. |

Advantageously, the calculated impact score can be used to automate various interactions in multiple domains, such as performance management, workforce management, quality planning, evaluation, and coaching. For example, performance management can use the impact score for goal setting and supervisor incentives. The impact score can also be used to coach the supervisor or an agent that the supervisor manages. Workforce management can use the impact score to automatically schedule high-impact supervisors in shifts with high coaching requirements. In supervisor evaluations, the impact score can be shown to the supervisor to motivate the supervisor to improve.

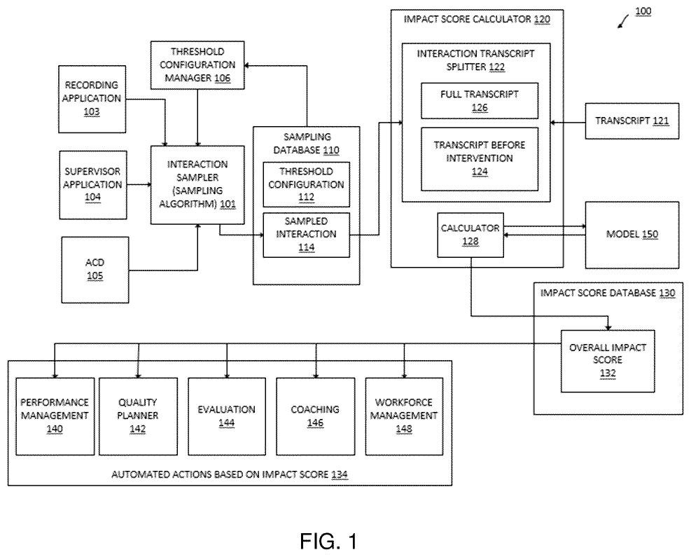

FIG. 1 illustrates a block diagram of an example environment 100 according to some embodiments of the present disclosure. As shown, environment 100 may include or implement a plurality of devices, servers, and/or software components that operate to perform various methodologies in accordance with the described embodiments. Exemplary devices and servers may include device, stand-alone, and enterprise-class servers, operating an operating system (OS) such as a MICROSOFT® OS, a UNIX® OS, a LINUX® OS, or another suitable device and/or server-based OS. It will be appreciated that the devices and/or servers illustrated in FIG. 1 may be deployed in other ways and that the operations performed, and/or the services provided, by such devices and/or servers may be combined or separated for a given embodiment and may be performed by a greater number or fewer number of devices and/or servers. For example, machine learning (ML), neural network (NN), and other artificial intelligence (AI) architectures have been developed to improve predictive analysis and classifications by systems in a manner similar to human decision-making, which increases efficiency and speed in performing predictive analysis of transaction data sets. One or more devices and/or servers may be operated and/or maintained by the same or different entities.

As shown, environment 100 includes an interaction sampler 101, a recording application 103, an automated caller dialer (ACD) 105, a supervisor application 104, a threshold configuration manager 106, a sampling database 110, an impact score calculator 120, an impact score database 130, transcripts 121, models 150, and automated actions based on impact score 134.

According to various embodiments, recording application 103 is responsible for recording of audio or video packets sent over session initiation protocol (SIP) to web real-time communications (WebRTC) protocols. For example, recording application 103 may transcribe a written transcript of an interaction with a customer from the audio or video packets, and send the transcript to interaction sampler 101. In some embodiments, recording application 103 may generate one or more transcripts 121. In several embodiments, the final recorded media file and one or more corresponding transcripts are uploaded to a scalable distributed storage device using a file storage device (not shown). The file storage device may be a cloud-based or other service used to upload and download recorded audio, screen media files, and transcripts to and from a storage location.

In one or more embodiments, supervisor application 104 is used by one or more supervisors in a contact center to observe and/or review ongoing customer interactions within their assigned team of agents. In some embodiments, supervisor application 104 provides intervention functionalities to the supervisor such as, but not limited to, the ability to search for an agent, configure skills of the agent, monitor the interaction, real-time coach the agent in the interaction, join the interaction as another participant and/or take over interactions with the customer from the agent. For example, supervisor application 104 may provide supervisor intervention action details for an interaction to interaction sampler 101.

In some embodiments, the automatic caller dialer 105 (ACD 105) is a service (or specialized equipment) that accepts an incoming interaction and routes it to an agent. This service (or equipment) may also facilitate outbound interactions from the agent to customers. For example, ACD 105 may send supervisor talk time and/or messaging data to interaction sampler 101. When a supervisor intervenes in an interaction, ACD 105 may capture details about the supervisor intervention, such as, for example without limitation, interaction identification, talk time of the supervisor and/or message count of the supervisor. These details may be sent to interaction sampler 101.

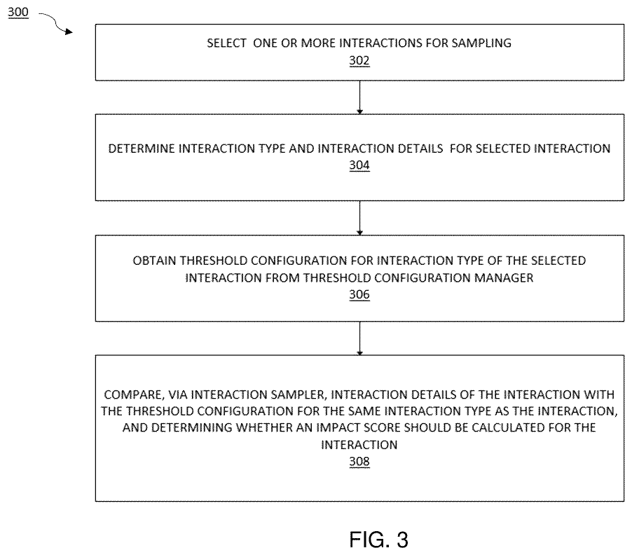

In one or more embodiments, interaction sampler 101 is a service (or equipment) that is responsible for sampling interactions for which an impact score needs to be calculated. The service (or equipment) compares interaction data against various sampling thresholds to decide whether a particular interaction needs to be sampled or not. Further discussion of this decision process is discussed below and in FIG. 3.

In some embodiments, threshold configuration manager 106 may expose representational state transfer (REST) endpoint application program interfaces (APIs) to configure one or more sampling thresholds used by interaction sampler 101. The sampling threshold configurations 112 are stored in sampling database 110. Sampling database 110 may store the sampling threshold configurations as well as one or more sampled interactions 114. In some embodiments, if the interaction data for an interaction meets one or more sampling thresholds, the interaction may be labeled as a sampled interaction 114.

Sampled interactions 114 are interactions that are selected by interaction sampler 101 to be used to calculate an impact score. Sampled interactions 114 are sent as input to impact score calculator 120. Transcripts 121 of the sampled interactions 114 are sent to impact score calculator 120 as well.

According to various embodiments, impact score calculator 120 is responsible for calculating the impact score for each interaction. In various embodiments, impact score calculator 120 includes interaction transcript splitter 122 and calculator 128. After receiving sampled interaction 114 and transcript 121, interaction transcript splitter 122 identifies a supervisor intervention point. A supervisor intervention point may be a point of time when a supervisor intervened in an interaction. A supervisor may intervene by, for example but not limited to, coaching, joining, or taking over the interaction. In some embodiments, interaction transcript splitter 122 processes transcript 121 to generate a full transcript 126. In certain embodiments, full transcript 126 may be a portion of transcript 121. In other embodiments, full transcript 126 may be the entirety of transcript 121 for a sampled interaction 114. Interaction transcript splitter 122 is responsible for identifying the point of time when a supervisor intervened in the interaction, and may also be responsible for creating a transcript before intervention 124, which is the transcript of the interaction for the duration of before the supervisor intervened. In some embodiments, transcripts before intervention 124 may be generated using the full transcript 126. In other embodiments, transcripts before intervention may be generated using transcript 121.

In several embodiments, interaction transcript splitter 122 retrieves transcript 121 from file storage service and supervisor action details from sampling database 110, and identifies the supervisor intervention point in transcript 121. Full transcript 126 and transcript before intervention 124 are passed to models 150 to calculate scores for the models or behavioral factors 150.

In one or more embodiments, there may be multiple supervisor intervention points identified by interaction transcript splitter 122 for a sampled interaction 114. In these embodiments, there may be one or more transcripts before intervention 124 that are generated.

In some embodiments, transcripts before intervention 124 and full transcript 126 are sent to calculator 128. In various embodiments, calculator 128 is responsible for calculating the supervisor impact score 132 for each supervisor intervention point. In some embodiments, there may be multiple supervisor intervention points and therefore there may be impact scores calculated for each intervention point. In several embodiments, the service uses various models or behavioral factors to calculate the customer experience score for the part of the interaction before the supervisor intervened and for the entire interaction. The impact score is calculated by comparing the customer experience scores before the intervention and for the entire interaction. In various embodiments, the impact score is saved in impact score database 130. Impact score database 130 stores the impact score for various supervisor intervention points for each sampled interaction 114.

In certain embodiments, models or behavioral factors 150 include one or more pre-existing machine learning models that are designed to evaluate distinct features of an interaction. In some embodiments, models or behavioral factors 150 may be based on, for example without limitation, convolutional neural networks (CNN) or Support Vector Machine (SVM) regression. CNN models take a vector of words as input. Scores generated by CNN models fall within a range of 0 to 1, which reflects the degree to which a specific feature, behavior, or event is present in an interaction. SVM regression models take a vector of phrases' occurrences as input. Scores generated by SVM regression models produce scores that fall within the range of −infinity to +infinity. In some cases, SVM regression models can be calibrated. In this process, a mapping function, which transforms model scores to fall within the range of 0 to 1, is added to the model.

Models or behavioral factors 150 take text representing the interaction as input and generate a score that corresponds to a particular feature. For example, the feature may include the sentiment of an interaction, a particular action of the participant, or an event that occurred during the interaction.

After determining impact scores for each of the plurality of behavioral factors, calculator 128 may aggregate the impact scores and determine an average of the impact scores to provide an overall impact score 132 for the supervisor action that was used to generate the supervisor intervention point.

In several embodiments, the overall impact score 132 is saved in the impact score database 130. In some embodiments, impact score database 130 stores the calculated impact scores for the plurality of behavioral factors. In one or more embodiments, impact score database 130 may be any suitable database for such storage (e.g., a MySQL database, PostgreSQL database, etc.).

The impact score database 130 and overall impact score 132 can be accessed by any required applications to trigger automated actions based on overall impact score 132. Automated actions based on impact score 134 may include actions taken by performance management (PM) application 140, quality planner application 142, evaluation application 144, coaching application 146, and/or workforce management (WFM) application 148.

In some embodiments, PM application 140 can utilize the overall impact score 132 as a metric for supervisors. PM application 140 may automatically evaluate the overall impact score 132 over time against various objectives and determine performance-linked incentives of supervisors. Similarly, there may be gamification pursuits created by PM application 140 using impact score metrics. In some embodiments, PM application 140 may include, for example, a gamification engine to automatically fetch the overall impact score 132 and evaluate gamification pursuits to determine completion.

In some embodiments, quality planner application 142 may be an automated tool for distributing future interactions of an agent to a senior agent or to evaluators to evaluate the agent's performance based on overall impact scores 132. The tool may use the overall impact score 132 as one of the filters for selection of interactions for quality assessment.

In one or more embodiments, an organizational customer of the contact center may define criteria for interactions to be selected. Quality planner application 142 may be run at various intervals throughout a given time period (e.g., every 30 minutes in a 24 hour time period) and select interactions as per the defined criteria. An impact score may be calculated for one or more of these selected interactions. The organizational customer may then see which interactions had positive or negative impact scores, and determine which agents may need quality improvement. For example, if an agent repeatedly has interactions with a highly positive supervisor impact score, that may indicate an agent may need additional training to improve the quality of their work such that the supervisor's impact on an interaction is lesser in magnitude.

In some embodiments, evaluation application 144 distributes the interaction to one or more of the following: an organizational client, the supervisor, or the agent for evaluation.

In some embodiments, coaching application 146 may include an automated coaching distribution algorithm that uses overall impact score 132 over a selected period of time as an input to assign coaching resources (e.g., coaching plans, coaching content, etc.) to an agent and/or to a supervisor. For example, coaching application 146 may assign coaching resources to agents for whom supervisor impact scores are consistently high.

In one or more embodiments, coaching application 146 may identify supervisors with low or negative impact scores over a selected period of time, and assign coaching resources automatically. A low or negative impact score indicates that the supervisor is in need of coaching. In other embodiments, coaching application 146 may identify and record interactions where supervisor impact scores are highly positive, so that they may be used as coaching content.

WFM application 148 uses an automated scheduling algorithm to generate the schedules for employees based on available forecasts, skills, and preferences of the employees. In some embodiments, WFM application 148 may include using overall impact scores 132 to automatically schedule supervisors with high impact scores to shifts with high coaching requirements. For example, WFM application 148 may identify shifts in which a maximum, a considerable or a significant number of agents and/or supervisors have been identified by coaching application 146 and may assign coaching resources. WFM application 148 may automatically schedule supervisors with high impact scores to these identified shifts to further assist with coaching needs, e.g., of a given agent or of a particular skill across a group of agents.

The general data flow through the environment 100 is as follows in the exemplary embodiment described below: ACD 105 connects an inbound or outbound customer interaction to available agents. When a supervisor intervenes in the interaction ACD 105 captures the details of this activity, and the details are sent from ACD 105 to interaction sampler 101.

Supervisor application 104 allows supervisors to initiate intervention actions, and has information about supervisor actions such as performed action, time of intervention, supervisor ID, interaction ID, and duration of interaction. This information is sent to interaction sampler 101.

Recording application 103 records the interaction, generates an interaction transcript 121, and records the media file. Interaction transcript 121 is typically stored in a file storage service, and is used by interaction sampler 101.

Threshold configuration manager 106 stores the threshold configuration data for each tenant and exposes this data over REST APIs. Interaction sampler 101 invokes these REST APIs to retrieve the sample threshold. A organizational customer or manager can configure the threshold configuration data for voice and digital interactions.

According to various embodiments, interaction sampler 101 receives supervisor talk time and number of messages sent by a supervisor from ACD 105, supervisor intervention action details from supervisor application 104, interaction transcripts from the file storage service, and sampling threshold configurations via REST API from threshold configuration manager 106. Using these inputs, interaction sampler 101 decides if the interaction should be sampled for impact score calculation or not. If the interaction is to be sampled, the details of the interaction are stored in sampling database 110.

In several embodiments, impact score calculator 120 picks up all the sampled interactions 114 from sampling database 110 and calculates the overall impact score 132. Interaction transcript splitter 122 takes sampled interaction 114 and retrieves the transcript 121 from the file storage service. Interaction transcript splitter 122 then identifies the time at which the supervisor intervened and creates a transcript for the portion of the interaction before the supervisor's intervention 124. The full transcript 126 and transcript before intervention 124 are sent to calculator 128.

In one or more embodiments, calculator 128 takes full transcript 126 and transcript before intervention 124 to passes the transcripts 124, 126 to models 150 to calculate customer experience scores and impact scores. The difference between the customer experience scores before supervisor intervention and for the entire interaction provides the impact score for the model or behavioral factor. In various embodiments, the impact scores and overall impact scores 132 are saved in impact score database 130, where they are available to other contact center applications. An application that requires an impact score can directly access impact score database 130, and a REST API can be created that provides access to impact score database 130. Other contact center applications (e.g., PM application 140, quality planner application 142, evaluation application 144, coaching application 146, and WFM application 148) can use the impact score to trigger applicable business functions.

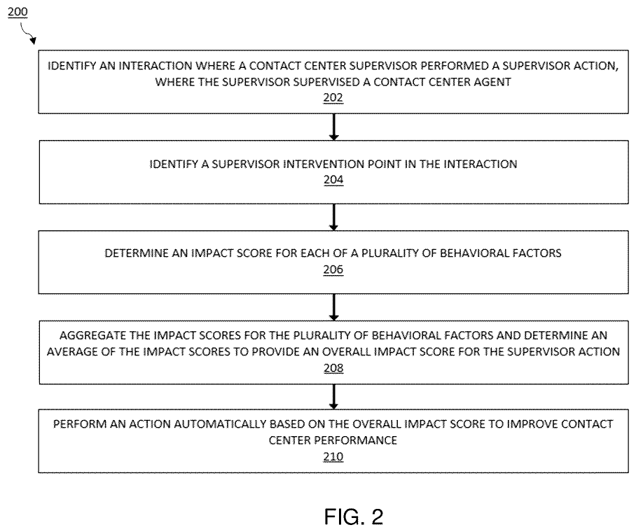

FIG. 2 is an exemplary flowchart 200 for measuring the impact of supervisor actions. Note that one or more steps, processes, and methods described herein of flowchart 200 may be omitted, performed in a different sequence, or combined as desired or appropriate based on the guidance provided herein. Flowchart 200 of FIG. 2 includes operations for determining a supervisor impact score, as discussed in reference to FIG. 1. One or more of steps 202-210 of flowchart 200 may be implemented, at least in part, in the form of executable code stored on non-transitory, tangible, machine-readable media that when run by one or more processors may cause the one or more processors to perform one or more of steps 202-210. In some embodiments, flowchart 200 can be performed by one or more computing devices discussed in environment 100 of FIG. 1.

Accordingly, at step 202 of flowchart 200, interaction sampler 101 identifies an interaction where a contact center supervisor performed a supervisor action. In one or more embodiments, a supervisor action (which also may be referred to as a supervisor intervention) may include, but is not limited to, coaching a contact center agent, joining the interaction, or taking control of the interaction from the agent.

In one or more embodiments, identifying an interaction includes receiving a threshold total talk time for a voice interaction from an organizational customer of the contact center, and determining that a total talk time of the supervisor in the interaction exceeds the threshold total talk time. In other embodiments, identifying an interaction may include receiving a threshold total number of messages for a digital interaction from an organizational customer of the contact center, and determining that a number of messages the supervisor sent in the interaction exceeds the threshold total number of messages. In still other embodiments, identifying an interaction may include receiving both a threshold total talk time for a voice interaction and a threshold number of messages for a digital interaction from an organizational customer of the contact center, and determining that the total talk time of the supervisor and/or the total number of messages the supervisor sent in the interaction exceeds the thresholds.

In some embodiments, interaction sampler 101 uses a sampling algorithm to identify interaction samples where the supervisor made a sufficient contribution. For example, a supervisor may start a coaching action and not speak a word. Here, the supervisor has not really contributed to the interaction. The sampling algorithm ignores such interactions with limited supervisor contribution and focuses on interactions where the supervisor provided a more significant contribution. In various embodiments, the contribution of the supervisor can be measured by the number of words spoken and/or the number of messages sent by the supervisor in the interaction. For example, for a digital interaction, in addition to the number of messages sent by the supervisor, the number of words within each message can be considered.

Referring now to FIG. 3, shown is an exemplary flowchart 300 for identifying interactions that should be sampled for an impact score. Note that one or more steps, processes, and methods described herein of flowchart 300 may be omitted, performed in a different sequence, or combined as desired or appropriate based on the guidance provided herein. Flowchart 300 of FIG. 3 includes operations for determining a supervisor impact score, as discussed in reference to FIG. 1. One or more of steps 302-308 of flowchart 300 may be implemented, at least in part, in the form of executable code stored on non-transitory, tangible, machine-readable media that when run by one or more processors may cause the one or more processors to perform one or more of steps 302-308. In some embodiments, flowchart 300 can be performed by one or more computing devices discussed in environment 100 of FIG. 1.

Accordingly, at step 302 of flowchart 300, one or more interactions are selected for sampling. In one or more embodiments, an interaction where a contact center supervisor performed a supervisor action may be selected for sampling.

At step 304, the interaction type and interaction details for the selected interactions are identified. In one or more embodiments, an interaction sampler 101 is responsible for making the identification. In some embodiments, the interaction type may include, without limitation, voice and/or digital interactions. In some embodiments, interaction details may be received from, for example without limitation, supervisor application 104, recording application 103, and/or ACD 105. In one or more embodiments, interaction details may include, without limitation, a total talk time of the supervisor in the interaction and/or a number of messages the supervisor sent in the interaction. In various embodiments, transcript 121 can be retrieved from file storage service (or equipment). It should be noted that, where a service is mentioned herein with respect to a feature of the disclosure, e.g., a recording service or file storage service, that equipment may alternatively be used.

Step 306 includes obtaining threshold configuration 112 for the interaction type of the selected interaction from threshold configuration manager 106. In one or more embodiments, a threshold configuration may include, for example without limitation, a threshold total talk time for a voice interaction and/or a threshold total number of messages for a digital interaction. In some embodiments, for digital interactions, a threshold number of words are also considered in the messages.

Step 308 includes comparing, via interaction sampler 101, interaction details of the interaction with the threshold configuration for the same interaction type as the interaction, and determining whether an impact score should be calculated for the interaction. For example, if the selected interaction is a voice interaction, interaction details may include a total talk time of the supervisor in the interaction. In this example, a threshold total talk time (e.g., 10 seconds) is used as the threshold configuration to compare the total talk time of the supervisor against. If the selected interaction is a digital interaction, interaction details may include a total number of messages, and the threshold number of messages (e.g., 2 messages) is used as the threshold configuration.

In one or more embodiments, if the threshold configuration for the interaction type of the selected interaction is exceeded, the interaction sampler 101 determines that an impact score for the selected interaction should be calculated. If the selected interaction, however, does not exceed the threshold configuration, the interaction is discarded and another interaction is selected.

Referring back to FIG. 2, at step 204, interaction transcript splitter 122 identifies a supervisor intervention point in the interaction. In one or more embodiments, a supervisor intervention point may be when a supervisor performs a supervisor action. In some embodiments, there may be one or more supervisor intervention points identified in an interaction. For example, a supervisor may first join an interaction, and then later take control of the interaction from the agent.

In some embodiments, the intervention transcript splitter 122 may generate various transcripts to be used for calculating the impact score. For example, interaction transcript splitter 122 may be used to generate a full transcript 126 as well as a transcript from the start of the interaction to the supervisor intervention point (e.g., transcript before intervention 124). The transcript 121 may be generated by recording application 103.

At step 206, calculator 128 determines an impact score for each of a plurality of behavioral factors or models 150. The plurality of behavioral factors may include, but is not limited to, “demonstrating ownership,” “active listening,” “being empathetic,” “building rapport, “setting expectations,” “effective questioning,” “promoting self-service,” “acting inappropriately,” “acknowledging loyalty,” “speaking at a high speed” (high speech velocity), and/or “interrupting the customer in the interaction,” or any combination thereof. In one or more embodiments, determining an impact score for a behavioral factor may involve calculating a first score for the behavioral factor of the agent before the supervisor intervention point, and calculating a second score for the behavioral factor of the agent for the entire interaction. In some embodiments, the impact score includes a difference between the calculated first score and the calculated second score. In one or more embodiments, the first and second scores for the behavioral factors of the agent are generated using one or more machine learning models (e.g., models 150 in FIG. 1).

In some embodiments, calculator 128 determines the impact score for each supervisor action (e.g., coach, join, or takeover) performed in the interaction to determine the impact of the supervisor's individual actions.

At step 208, calculator 128 aggregates the impact scores for the plurality of behavioral factors, and an average of the impact scores is determined, to provide an overall impact score 132 for the supervisor action. Depending on product needs, however, an administrator can also provide weights to each factor and calculated a weighted average.

To compute the overall impact score 132, all the models' scores should be in the same range, e.g., 0-100. In some embodiments, calibrated models that produce scores between 0 and 1 can be used. In other embodiments, the scores are normalized by assuming the scores are in a certain range, e.g., −30 and +30.

In several embodiments, the first score for the behavioral factor of the agent before the supervisor intervention point and second score for the behavioral factor of the agent for the entire interaction may be normalized by the model before the difference between the two scores is calculated. In other embodiments, the impact score for each behavioral factor is normalized before the overall impact score is calculated. An example of a formula for normalizing scores is:

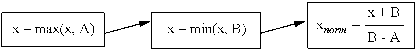

where x is the first or second score for the behavioral factor, A is the lower boundary of the score range, and B is the upper boundary of the model score range.

At step 210, an action is automatically performed based on the overall impact score 132 to improve contact center performance. In one or more embodiments, this action may include, without limitation, project management, quality planning, evaluation, coaching, and/or workforce management. In some embodiments, these actions may represent, without limitation, one or more of PM application 140, quality planner application 142, evaluation application 144, coaching application 146, and/or WFM application 148 in FIG. 1.

PM applications in contact centers provide capabilities to define key performance indicators (KPIs) for agents or teams, individual or team goals, and objectives around KPIs. Some advanced PM applications provide gamification features on goals and objectives. The PM applications can extract the values of the KPIs from a database and use the KPI values within the application.

Contact center managers define goals on the KPIs, which includes the target value that needs to be achieved by the individual agent or team. When the goals or objectives are met, such achievements can be considered in the payroll of the agents. By adding the supervisor impact score as a KPI, PM application 140 can be used to automate supervisor performance tracking, goal and objectives, and automate the incentives given to supervisors.

In one or more embodiments, PM application 140 evaluates if the goal for a supervisor (e.g., a goal for a supervisor impact score KPI) was reached. In some embodiments, PM application 140 retrieves the goal for one or more KPIs from the goal and objective service, and obtains the aggregated value of the KPI for the defined period from the metric manager service. The KPI aggregated value is used to calculate the metric value by putting the KPI value in the metric formula, e.g., KPI value*10/100. PM application 140 then evaluates the calculated metric value of the KPI to determine if the goal was achieved. If the goal is achieved, this is marked in the goal database. Afterwards, one or more notifications can be sent to the manager who defined the goal, including details about the goal, the metric, and the supervisor who achieved the goal. The goal details can then be stored and shown as achieved in the dashboards and reports.

Quality planning is a service that is used to automate the distribution of interactions for evaluation. When creating a quality plan, a quality manager can define criteria for interactions to be selected for evaluation. The quality planner can run every 30 minutes, select an interaction per the defined criteria, distributes it to the evaluator for evaluation. In various embodiments, the impact score calculated for each interaction can be added to the quality planner as an additional criterion. Thus, the quality planner can automatically distribute an interaction with a positive or a negative impact score. The fact that a supervisor joined the interaction, contributed, and had a good impact score is an accurate indicator that the agent needs quality improvement. Such interactions would be good candidates to evaluation.

In certain embodiments, quality planner application 142 obtains all tenants from the tenant manager. For each tenant, quality planner application 142 retrieves the active quality plan. For each plan, quality planner application 142 acquires the agents whose interactions need to be distributed for evaluation. Quality planner application 142 obtains the interactions that meet the criteria specified in the quality plan. In several embodiments, the criteria includes the supervisor impact score for the interaction. The interactions are then distributed among evaluators for evaluation. In some embodiments, the interactions are saved into a sample database before they are distributed.

In one or more embodiments, coaching application 146 serves as an automatic coaching distributor that is responsible for automatically assigning coaching to the agent and/or the supervisor. The automatic assignment of the coaching can be controlled by configuring a coaching plan, where the coaching plan defines the condition(s) when coaching needs to be assigned (e.g., based on supervisor impact score), the content of the coaching session, the due date, and the participants. Coaching application 146 can periodically (e.g., once or twice a day) run the coaching plan by calculating if the coaching condition is met. When the coaching condition defined in the coaching plan is met, coaching application 146 assigns coaching to the coaching participants defined in the coaching plan.

In several embodiments, coaching application 146 initially fetches the overall impact score for each of the interactions where the supervisor intervened for the last plan period. Next, coaching application 146 calculates the average impact score for all the interactions retrieved. Coaching application 146 then checks if the average impact score of the supervisor is less than the threshold defined in a coaching plan. If the average impact score is less than the threshold, this indicates that the supervisor did not have the expected impact on the customer experience and thus needs to be coached. Coaching content is then assigned to the supervisor by coaching application 146.

In some embodiments, coaching application 146 retrieves all the interactions attended to by an agent for the last plan period and retrieves the impact score for each interaction. An average of the impact scores for all interactions handled by the agent is calculated. Coaching application 146 then checks if the average supervisor impact is greater than that defined in the coaching plan. If the impact score is greater than the threshold, this indicates that the supervisor improved the customer experience, thus indirectly indicating that the agent himself was not able to have a positive impact on the customer experience and needs to be coached. Coaching application 146 then assigns coaching to the agent.

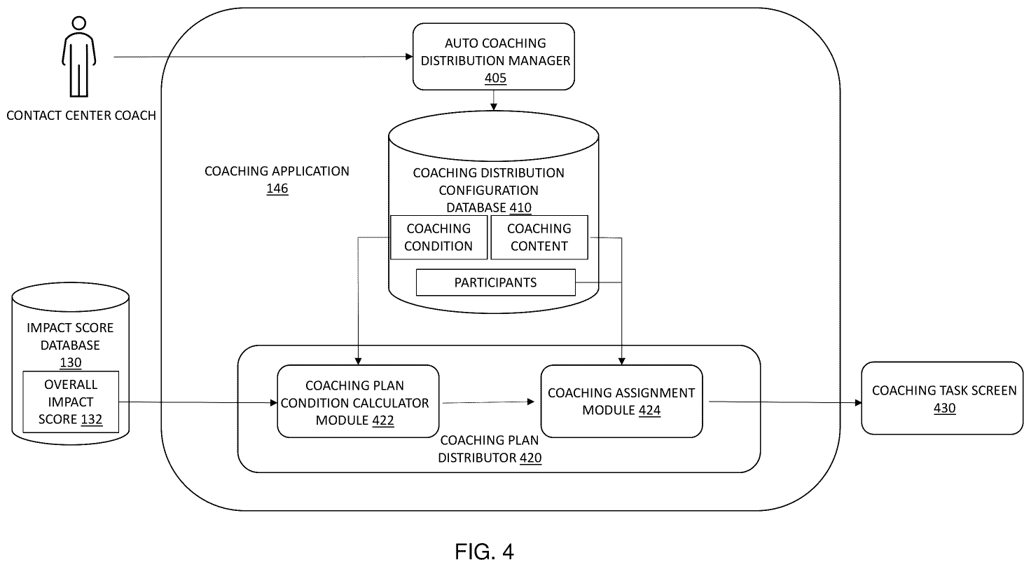

FIG. 4 illustrates that coaching application 146 can act as an automatic coaching distributor module, including automatic coaching distribution manager 405. This component or service provides REST endpoints that can be used by the contact center coach to create coaching plans. The coaching plan condition can be defined as “If the average supervisor impact score for last week is less than zero, then the supervisor needs to be assigned coaching content that will teach him to better handle the interaction and have higher impact.” The coaching condition and coaching condition are saved in the coaching distribution configuration database 410. Coaching distribution configuration database 410 is any suitable database that can save coaching plan entities, such as MySQL, PostgreSQL, and Mongo DB.

Coaching plan distributor 420 wakes up at a scheduled interval and starts the distribution process by triggering the coaching plan condition calculator module 422. The coaching plan condition calculator module 422 is responsible for calculating the result of the coaching condition defined by the contact center coach. The coaching plan condition calculator module 422 pulls the overall impact score 132 for each supervisor from impact score database 130 and checks if the coaching condition is met. For all those supervisors where the coaching condition is met, the configured contacting content needs to be assigned. For assignment of coaching content, the coaching assignment module 424 is invoked.

The coaching assignment module 424 is responsible for the distribution and assignment of coaching content to supervisors and agents. It picks up the coaching content and sends the content to the coaching task screen 430 of a supervisor or agent.

Automated staffing or schedule generation is based on a staffing plan forecast and static parameters like shift templates or weekly rules that need to be configured in the system before generating the schedules. An automated schedule generator typically generates schedules by performing scheduling algorithms on approved inputs. Input to the automated schedule generator is enhanced with addition of the supervisor impact score. In one or more embodiments, supervisors with a high impact score can be scheduled in shifts with high coaching requirements. In certain embodiments, the schedule for the agents is generated first, and subsequently the schedule for the supervisors is generated so that the shifts with the highest coaching requirements can be identified.

In some embodiments, WFM application 148 retrieves input parameters and configurations for supervisor and agent scheduling such as scheduling units, date range for scheduling, shift templates, and weekly rules. WFM application 148 then generates a schedule for agents in a given scheduling unit and date range. Next, WFM application 148 obtains the coaching requirement data for the agents, including the agents who are marked for coaching for a specific scheduling unit. Supervisors are then sorted in descending order according to their impact score with the supervisor having the highest impact score at the top of the list. For the agent schedule, WFM application 148 calculates the number of agents that require coaching in each shift from the coaching requirement data. WFM application 148 subsequently sorts the shifts in descending order with the shift having the highest number of agents with coaching requirements at the top of the list. For each shift, WFM application 148 assigns a supervisor in the order of the highest impact score and creates a schedule for that supervisor for that shift. WFM application 148 then returns the updated schedule to the schedule manager.

Below are the full data structures of the data used in the present invention.

### 1. Sampled Interaction Details

```
{
  “interactionId”: “int_123”,
  “agentId”: “agent_456”,
  “skill”: “finance”,
  “direction”: “inbound”,
  “channelType”: “voice”,
  “interactionStartTime”: “11-3-2022T5:00:00Z”,
  “interactionEndTime”: “11-3-2022T5:15:00Z”,
  “supervisorInterventionDetails”: {
    “supervisorId”: “sup_789”,
    “supervisorName”: “James Bond”,
    “action”: “Coach”,
    “startTime”: “11/3/2022T5:03:00Z”,
    “endTime”: “11/3/2022T5:06:00Z”,
    “durationSec”: 180,
    sequence”: 1
  }
}
```

### 2. Supervisor Intervention Action Details

```
{
  “interactionId”: “int_123”,
  “channelType”: “voice”,
  “supervisorId”: “sup_789”,
  “supervisorName”: “James Bond”,
  “action”: “Coach”,
  “startTime”: “11/3/2022T5:03:00Z”,
  “endTime”: “11/3/2022T5:06:00Z”,
  “durationSec”: 180,
  “sequence”: 1
}
```

### 3. Supervisor's Contribution Details

```
// Sample entity for voice interaction
{
  “interactionId”: “int_123”,
  “channelType”: “voice”,
  “supervisorId”:“sup_789”,
  “talkTimeSec”: 120,
  “noOfMsg”: 0
}
// Sample entity for chat interaction
{
  “interactionId”: “int_123”,
  “channelType”: “chat”
  “supervisorId”:“sup_789”,
  “talkTimeSec”: 0,
  “noOfMsg”: 10
}
```

### 4. Sampling Threshold

```
// Sample entity for voice interaction
{
  “channel”: “voice”,
  “thresholdSec”: 30,
  “thresholdCount”: 0
}
// Sample entity for chat interaction
{
  “channel”: “chat”,
  “thresholdSec”: 0,
  “thresholdCount”: 1
}
```

### 5. Model Result for Each Model

{
“interactionId”: “int_123”,
“model”: “acknowledgeLoyalty”,
“score”: 0.6480266,
“endTime”: “2022-11-23T09:37:40.874Z”,
“startTime”: “2022-11-23T09:07:47.032Z”,
“tenantId”: “11ec3034-9065-3ff0-8637-0242ac110003”,
“totalDuration”: 82
}

### 6. Supervisor Impact Score

```
{
  “interactionId”: “int_123”,
  “agentId”: “ agent_456”,
  “supervisorId”: “sup_789”,
  “action”: “Coach”,
  “actionStartTime”: “11/3/2022T5:03:00Z”,
  “actionEndTime”: “11/3/2022T5:06:00Z “,
  “impactScore”: 3.51
}
```

### 7. Chat Interaction Transcript

```
{
  “id”: 124553,
  “interactionId”: “ad86d017-19a7-405f-be50-90de2035213d”,
  “tenantId”: “11ed1163-441d-0360-ac0b-0242ac110005”,
  “massages”: [
    {
      “id”: 1,
      “senderType”: “customer”,
      “senderId”: “customer@socialmedia.com”,
      “msg”: “I need help with password”,
      “timestamp”: “2022-09-17 19:08:16.259”
    },
    {
      “id”: 2,
      “senderType”: “Agent”,
      “senderId”: “Bob”,
      “msg”: “Sure, how can I help you?”,
      “timestamp”: “2022-09-17 19:08:16.712”
    },
    {
      “id”: 3,
      “senderType”: “customer”,
      “senderId”: “customer@socialmedia.com”,
      “msg”: “I forgot my password”,
      “timestamp”: “2022-09-17 19:08:21.349”
    },
    {
      “id”: 4,
      “senderType”: “Supervisor”,
      “senderId”: “Alice”,
      “msg”: “Show empathy and suggest using self-service portal
https://nice.com”,
      “timestamp”: “2022-09-17 19:08:26.456”
    },
      {
        “id”: 4,
        “senderType”: “Agent”,
        “senderId”: “Bob”,
        “msg”: “I'm sorry to hear that. You can reset it at our website
      https://nice.com”,
        “timestamp”: “2022-09-17 19:08:29.967”
```

Assume a customer is in financial distress. He calls the contact center to explain that he cannot make the payments on time. The agent he speaks to explains that the customer will face a late penalty. Also, services could be discontinued if the payment is delayed beyond a certain date. Table 2 below provides interaction scores for the interaction before supervisor intervention. The scores show low guidance on multiple factors.

TABLE 2
INTERACTION SCORES BEFORE
SUPERVISOR INTERVENTION

| MODEL/BEHAVIORAL | SCORE BEFORE |
|---|---|
| FACTOR | INTERVENTION |
| Build Rapport | −1.23 |
| Be Empathetic | −2.14 |
| Interruption | 0.34 |
| Acknowledge Loyalty | −1.89 |

At this stage during the interaction, the supervisor coaches the agent and makes several suggestion. Based on the supervisor's suggestion, the agent appreciates the customer for being a long-time customer with an excellent payment record. The agent also asks why the customer is unable to make a payment at this time. The customer explains that he lost employment due to the COVID pandemic. The agent expresses empathy. Meanwhile, the supervisor also shares details of a COVID relief payment plan. The agent now informs the customer that payment terms can be relaxed per the company's COVID relief payment plan. He also explains the documentation required. The customer thanks the agent for making an exception and providing relief as he intends to continue services in the future. Table 3 below provides interaction scores for the interaction after supervisor intervention. The scores show improvement on multiple factors.

TABLE 3
INTERACTION SCORES AFTER
SUPERVISOR INTERVENTION

| MODEL/BEHAVIORAL | SCORE AFTER |
|---|---|
| FACTOR | INTERVENTION |
| Build Rapport | 2.76 |
| Be Empathetic | 2.94 |
| Interruption | −1.04 |
| Acknowledge Loyalty | 2.01 |

### EXAMPLES

A customer's dataset was used, and a few interactions with a supervisor intervention were identified. For each interaction, a version of the interaction before the intervention was created by manually removing the ending of the interaction. Nine (9) customer satisfaction models or behavioral factors were run on the whole interaction and the portion of the interaction before intervention. The results were correlated to the actual occurrences in the interaction.

Below are the results for Interaction 1, where the supervisor managed to improve the agent's performance and thus the customer interaction.

Table 4 shows interaction scores for Interaction 1 before normalization.

TABLE 4
INTERACTION ONE SCORES BEFORE NORMALIZATION

| | | SCORE | | OVERALL |
|---|---|---|---|---|
| MODEL/ | SCORE | FOR | | IMPACT |
| BEHAV- | BEFORE | WHOLE | | SCORE |
| IORAL | INTERVEN- | INTERAC- | IMPACT | (WEIGHTED |
| FACTOR | TION | TION | SCORE | AVERAGE) |
| Sentiment | −5.69 | −5.31 | 0.68 | 2.233 |
| Acknowledge | −7.52 | −5.86 | 2.64 | |
| Loyalty | | | | |
| Active | −13.35 | −9.02 | 4.33 | |
| Listening | | | | |
| Be Empathetic | 14.59 | 10.82 | −3.77 | |
| Build Rapport | −0.9 | 2.79 | 3.69 | |
| Demonstrate | −6.67 | −5.57 | 1.10 | |
| Ownership | | | | |
| Effective | −9.65 | −4.71 | 4.94 | |
| Questioning | | | | |
| Inappropriate | −8.71 | −7.80 | 0.91 | |
| Action | | | | |
| Promote | −13.26 | −7.01 | 6.25 | |
| Self-Service | | | | |
| Set | 2.53 | 4.09 | 1.56 | |
| Expectations | | | | |

Table 5 shows interaction scores for Interaction 1 after normalization.

TABLE 5
INTERACTION ONE SCORES AFTER NORMALIZATION

| | | SCORE | | OVERALL |
|---|---|---|---|---|
| MODEL/ | SCORE | FOR | | IMPACT |
| BEHAV- | BEFORE | WHOLE | | SCORE |
| IORAL | INTERVEN- | INTERAC- | IMPACT | (WEIGHTED |
| FACTOR | TION | TION | SCORE | AVERAGE) |
| Sentiment | 40.52 | 41.15 | 0.63 | 3.51 |
| Acknowledge | 37.47 | 40.23 | 2.77 | |
| Loyalty | | | | |
| Active | 27.75 | 34.97 | 7.22 | |
| Listening | | | | |
| Be Empathetic | 74.32 | 68.03 | −6.28 | |
| Build Rapport | 48.50 | 54.65 | 6.15 | |
| Demonstrate | 38.88 | 40.72 | 1.83 | |
| Ownership | | | | |
| Effective | 33.92 | 42.15 | 8.23 | |
| Questioning | | | | |
| Inappropriate | 35.48 | 37.00 | 1.52 | |
| Action | | | | |
| Promote | 27.90 | 38.32 | 10.42 | |
| Self-Service | | | | |
| Set | 54.22 | 56.82 | 2.60 | |
| Expectations | | | | |

Below are the results for Interaction 2, where the supervisor did not manage to improve the situation.

Table 6 shows interaction scores for Interaction 2 before normalization.

TABLE 6
INTERACTION TWO SCORES BEFORE NORMALIZATION

| | | SCORE | | OVERALL |
|---|---|---|---|---|
| MODEL/ | SCORE | FOR | | IMPACT |
| BEHAV- | BEFORE | WHOLE | | SCORE |
| IORAL | INTERVEN- | INTERAC- | IMPACT | (WEIGHTED |
| FACTOR | TION | TION | SCORE | AVERAGE) |
| Sentiment | −3.24 | −5.94 | −2.70 | −1.383 |
| Acknowledge | 5.77 | 4.18 | −1.59 | |
| Loyalty | | | | |
| Active | −2.67 | −4.52 | −1.85 | |
| Listening | | | | |
| Be Empathetic | 7.18 | 9.38 | 2.2 | |
| Build Rapport | 2.32 | 1.82 | −0.5 | |
| Demonstrate | 3.15 | 0.16 | −2.99 | |
| Ownership | | | | |
| Effective | 3.46 | 2.26 | −1.2 | |
| Questioning | | | | |
| Inappropriate | −2.19 | −6.63 | −4.54 | |
| Action | | | | |
| Promote | −0.66 | −1.57 | −0.91 | |
| Self-Service | | | | |
| Set | 3.18 | 3.43 | 0.25 | |
| Expectations | | | | |

Table 7 shows interaction scores for Interaction 2 after normalization.

TABLE 7
INTERACTION TWO SCORES AFTER NORMALIZATION

| | | SCORE | | OVERALL |
|---|---|---|---|---|
| MODEL/ | SCORE | FOR | | IMPACT |
| BEHAV- | BEFORE | WHOLE | | SCORE |
| IORAL | INTERVEN- | INTERAC- | IMPACT | (WEIGHTED |
| FACTOR | TION | TION | SCORE | AVERAGE) |
| Sentiment | 44.60 | 40.10 | −4.50 | −2.29 |
| Acknowledge | 59.62 | 56.97 | −2.65 | |
| Loyalty | | | | |
| Active | 45.55 | 42.47 | −3.08 | |
| Listening | | | | |
| Be Empathetic | 61.97 | 65.63 | 3.67 | |
| Build Rapport | 53.87 | 53.03 | −0.83 | |
| Demonstrate | 55.25 | 50.27 | −4.98 | |
| Ownership | | | | |
| Effective | 55.77 | 53.77 | −2.00 | |
| Questioning | | | | |
| Inappropriate | 46.35 | 38.95 | −7.40 | |
| Action | | | | |
| Promote | 48.90 | 47.38 | −1.52 | |
| Self-Service | | | | |
| Set | 55.30 | 55.72 | 0.42 | |
| Expectations | | | | |

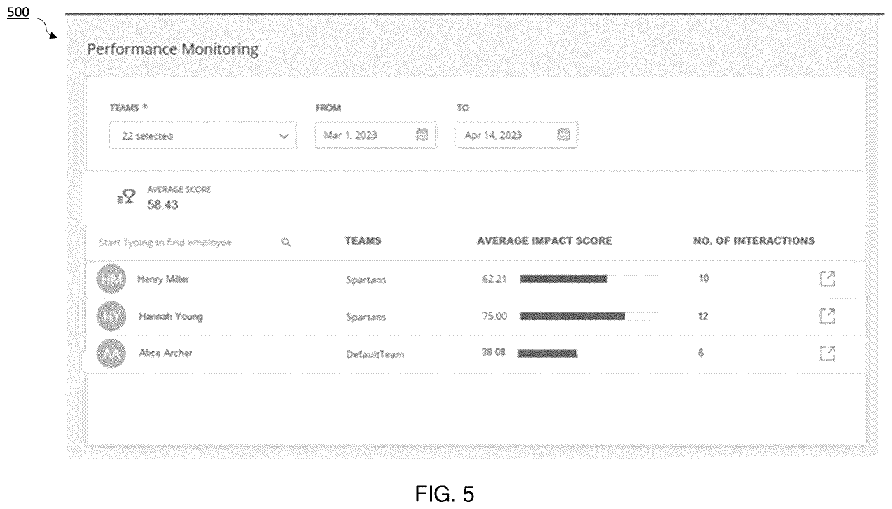

FIG. 5 is an exemplary user interface 500 for interacting with actionable insights generated by a system utilizing supervisor impact scores, according to some embodiments. Interface 500 may be a view available to managers of supervisors and/or agents to assess performance of the agents and/or supervisors they manage. In one or more embodiments, performance of individuals on a team may be viewed and/or compared. In some embodiments, performance of teams may be viewed and/or compared. In some embodiments, the insights on interface 500 may be used to decide incentives to supervisors as part of performance management.

In one or more embodiments, user interface 500 may be used in performance monitoring and/or management activities, and the overall impact score 132 may be used as a KPI. In other embodiments, the overall impact score 132 over multiple interactions may be averaged and displayed on the interface 400. For example, actionable insights may be viewed over a selected period of time, and the number of interactions during that time period from which an average impact score is calculated may be displayed as well.

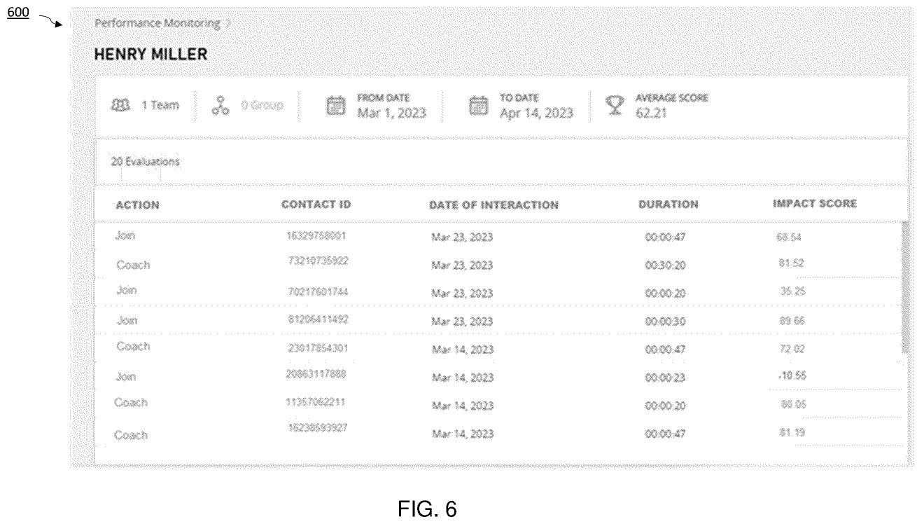

FIG. 6 is an exemplary user interface 600 for a team leader to view impact scores and related data, according to some embodiments. As shown, user interface 600 displays the breakdown of impact scores for each action of a supervisor. This is an alternative view that is presented to supervisors and managers to view impact scores for individual interactions and monitor performance between specific dates. An average score for the selected supervisor over the given date range may be provided as well. In some embodiments, interface 600 may be used to analyze where a supervisor was able to make an impact on an interaction (by having, for example, a positive impact score) or was not able to impact an interaction (by having, for example, a neutral or negative impact score). In certain embodiments, the impact score for each behavioral factor can also be shown so that the breakdown of the overall impact score for each interaction can be seen and understood by the supervisor.

Where applicable, various embodiments provided by the present disclosure may be implemented using hardware, software, or combinations of hardware and software. Also, where applicable, the various hardware components and/or software components set forth herein may be combined into composite components including software, hardware, and/or both without departing from the spirit of the present disclosure. Where applicable, the various hardware components and/or software components set forth herein may be separated into sub-components including software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although illustrative embodiments have been shown and described, a wide range of modifications, changes and substitutions are contemplated in the foregoing disclosure and in some instances, some features of the embodiments may be employed without a corresponding use of other features. One of ordinary skill in the art would recognize many variations, alternatives, and modifications of the foregoing disclosure. Thus, the scope of the present application should be limited only by the following claims, and it is appropriate that the claims be construed broadly and in a manner consistent with the spirit and full scope of the embodiments disclosed herein.

The Abstract at the end of this disclosure is provided to comply with 37 C.F.R. § 1.72(b) to allow a quick determination of the nature of the technical disclosure. It is submitted with the understanding that it will not be used to interpret or limit the scope or meaning of the claims.

What is claimed is:

1. A system adapted to measure impact of supervisor actions comprising:
at least one processor and a computer readable medium operably coupled thereto, the computer readable medium comprising a plurality of instructions stored in association therewith that are accessible to, and executable by, the at least one processor, to perform operations which comprise:
identifying an interaction where a contact center supervisor performed a supervisor action, where the supervisor supervised a contact center agent;
identifying a supervisor intervention point in the interaction;
determining an impact score for each of a plurality of behavioral factors,
aggregating the impact scores for the plurality of behavioral factors and determining an average of the impact scores to provide an overall impact score for the supervisor action; and
performing an action automatically based on the overall impact score to improve contact center performance.

2. The system of claim 1, wherein determining an impact score for each of the plurality of behavioral factors comprises:
calculating a first score for a plurality of behavioral factors of the agent before the supervisor intervention point, and
calculating a second score for the plurality of behavioral factors of the agent for the entire interaction,
wherein the impact score comprises a difference between (1) the calculated first score and (2) the calculated second score.

3. The system of claim 1, wherein identifying an interaction where a contact center supervisor performed a supervisor action comprises:
receiving, from an organizational customer of the contact center, one or more of a threshold total talk time for a voice interaction, a threshold total number of messages for a digital interaction, or a threshold total number of words for a voice or a digital interaction; and
determining that a total talk time of the supervisor in the interaction exceeds the threshold total talk time; or
determining a number of messages the supervisor sent in the interaction exceeds the threshold total number of messages; or
determining a total number of words used by the supervisor in the interaction exceeds the threshold total number of words.

4. The system of claim 1, wherein the supervisor action comprises coaching a contact center agent, joining the interaction, or taking control of the interaction from the agent.

5. The system of claim 1, wherein the plurality of behavioral factors comprises two or more of: demonstrating ownership, active listening, being empathetic, building rapport, setting expectations, effective questioning, promoting self-service, inappropriate actions, acknowledging loyalty, speech velocity, or interruptions.

6. The system of claim 1, which further comprises normalizing the calculated impact scores for the plurality of behavioral factors.

7. The system of claim 1, wherein performing an action automatically based on the overall impact score comprises:
automating performance evaluation of the supervisor; or
determining performance-linked incentives for the supervisor.

8. The system of claim 1, wherein performing an action automatically based on the overall impact score comprises:
scheduling the supervisor in a workforce management application; or
distributing the interaction to one or more of the following: an organizational client, the supervisor, or the agent for evaluation; or
assigning coaching to the supervisor or an agent associated with the interaction.

9. A method of measuring impact of supervisor actions, comprising:
identifying an interaction where a contact center supervisor performed a supervisor action, where the supervisor supervised a contact center agent;
identifying a supervisor intervention point in the interaction;
determining an impact score for each of a plurality of behavioral factors,
aggregating the impact scores for the plurality of behavioral factors and determining an average of the impact scores to provide an overall impact score for the supervisor action; and
performing an action automatically based on the overall impact score to improve contact center performance.

10. The method of claim 9, wherein determining an impact score for each of the plurality of behavioral factors comprises:
calculating a first score for a plurality of behavioral factors of the agent before the supervisor intervention point, and
calculating a second score for the plurality of behavioral factors of the agent for the entire interaction,
wherein the impact score comprises a difference between (1) the calculated first score and (2) the calculated second score.

11. The method of claim 9, wherein identifying an interaction where a contact center supervisor performed a supervisor action comprises:
receiving, from an organizational customer of the contact center, one or more of a threshold total talk time for a voice interaction, a threshold total number of messages for a digital interaction, or a threshold total number of words for a voice or a digital interaction; and
determining that a total talk time of the supervisor in the interaction exceeds the threshold total talk time; or
determining a number of messages the supervisor sent in the interaction exceeds the threshold total number of messages; or
determining a total number of words used by the supervisor in the interaction exceeds the threshold total number of words.

12. The method of claim 9, wherein the supervisor action comprises coaching a contact center agent, joining the interaction, or taking control of the interaction from the agent.

13. The method of claim 9, wherein the plurality of behavioral factors comprises two or more of: demonstrating ownership, active listening, being empathetic, building rapport, setting expectations, effective questioning, promoting self-service, inappropriate actions, acknowledging loyalty, speech velocity, or interruptions.

14. The method of claim 9, which further comprises normalizing the calculated impact scores for the plurality of behavioral factors.

15. The method of claim 9, wherein performing an action automatically based on the overall impact score comprises:
automating performance evaluation of the supervisor; or
determining performance-linked incentives for the supervisor.

16. The method of claim 9, wherein performing an action automatically based on the overall impact score comprises:
scheduling the supervisor in a workforce management application; or
distributing the interaction to one or more of the following: an organizational client, the supervisor, or the agent for evaluation; or
assigning coaching to the supervisor or an agent associated with the interaction.

17. A non-transitory computer-readable medium having stored thereon computer-readable instructions executable by at least one processor to perform operations which comprise:
identifying an interaction where a contact center supervisor performed a supervisor action, where the supervisor supervised a contact center agent;
identifying a supervisor intervention point in the interaction;
determining an impact score for each of a plurality of behavioral factors,
aggregating the impact scores for the plurality of behavioral factors and determining an average of the impact scores to provide an overall impact score for the supervisor action; and
performing an action automatically based on the overall impact score to improve contact center performance.

18. The non-transitory computer-readable medium of claim 17, wherein determining an impact score for each of the plurality of behavioral factors comprises:
calculating a first score for a plurality of behavioral factors of the agent before the supervisor intervention point, and
calculating a second score for the plurality of behavioral factors of the agent for the entire interaction,
wherein the impact score comprises a difference between (1) the calculated first score and (2) the calculated second score.

19. The non-transitory computer-readable medium of claim 17, wherein identifying an interaction where a contact center supervisor performed a supervisor action comprises:
receiving, from an organizational customer of the contact center, one or more of a threshold total talk time for a voice interaction, a threshold total number of messages for a digital interaction, or a threshold total number of words for a voice or a digital interaction; and
determining that a total talk time of the supervisor in the interaction exceeds the threshold total talk time; or
determining a number of messages the supervisor sent in the interaction exceeds the threshold total number of messages; or
determining a total number of words used by the supervisor in the interaction exceeds the threshold total number of words.

20. The non-transitory computer-readable medium of claim 17, wherein performing an action automatically based on the overall impact score comprises:
automating performance evaluation of the supervisor; or
determining performance-linked incentives for the supervisor; or
scheduling the supervisor in a workforce management application; or
distributing the interaction to one or more of the following: an organizational client, the supervisor, or the agent for evaluation; or
assigning coaching to the supervisor or an agent associated with the interaction.
